(19) United States
(12) Patent Application Publication
(10) Pub. No.: US 2017/0316778 A1
(43) Pub. Date: Nov. 2, 2017

(54) Synchronized voice application to present accurate real time content uttered by a text reader/reciter

(71) Applicant: Hicham Elhayboubi, Tampa, FL (US)

(72) Inventor: Hicham Elhayboubi, Tampa, FL (US)

(21) Appl. No.: 15/495,929

(22) Filed: Apr. 24, 2017

Related U.S. Application Data
(60) Provisional application No. 62/391,489, filed on May 2, 2016.

(51) Int. Cl. G10L 15/22; G06F 17/30; G06F 3/16; G10L 15/18; G10L 15/30; G10L 15/08

(52) U.S. Cl. CPC G10L 15/22; G10L 15/1815; G06F 17/30746; G10L 15/30; G06F 3/167; G06F 17/30752; G10L 2015/088; G10L 2015/221

(57) ABSTRACT

The embodiments of the invention allows retrieval of information or processing of commands through a speech interface and/or a combination of a speech interface and a non-speech interface. Thus, facilitating verbal search of religious and non-religious texts, and publishing resulting finds, along with exegesis and/or explanations. Beneficial uses can be gotten in the fields of, but not limited to those fields, of religious worship, and education. The embodiments of the invention eases interaction of the user(s) with the text(s) and allows for chances of in-depth comprehension and greater access to knowledge, but not limited only to those benefits. The scope and ramifications of the use(s) and benefits cannot be measured in a limited manner. As technology and imagination increases, the true scope and ramifications would increase as well.

### CROSS REFERENCE TO RELATED APPLICATION

This application claims the benefit of PPA application number U.S. 62/391,489 filing date May 2, 2016 by present inventor, which is incorporated by reference.

### FIELD OF THE INVENTION

The invention relates to retrieval of information or processing of commands through a speech interface and/or a combination of a speech interface and a non-speech interface. More specifically, the invention provides a fully integrated environment that allows users to submit natural language questions and commands via the speech interface and the non-speech interface. Information may be obtained from a wide range of disciplines, making local and network inquiries to obtain the information and presenting results in a natural manner, even in cases where the question asked or the responses received are incomplete, ambiguous or subjective. The invention may further allow users to control devices and systems either locally or remotely.

### BRIEF SUMMARY OF THE INVENTION AND PRIOR ART

As this invention relates to the facilitation of explanations/commentaries of related texts via a publish, retrieve-recall, and broadcast method using automatic speech recognition (ASR) system. For the sake of clarity, we have decided to explain the embodiments of this invention through the scope of the fields of education and religious practices. Yet, the embodiment(s) of the related invention is not limited to these two fields solely, and may encompass and branch out to other areas of interest that may be to users' imagination.

Firstly, considering the field of religious practices, religions have strong faith or confidence in their religious texts, which ever they may be. Here, religious texts, also known as scriptures or holy books, can be defined as texts which various religious traditions consider to be sacred, or fundamental to their religious tenets. These religious texts are believed by their beholders to be divinely or supernaturally brought out or inspired. As a result, these texts are often used during religious services in congregations and outside congregations by individual followers, making religious texts fundamental to spiritual faith and piety.

An example could be illustrated with the Holy Quran, which Muslim worshippers are expected to read/recite on a frequent basis during daily prayers. Worshippers are also encouraged to memorize the holy book and study its meanings. With the advent of the digital world and of hand-held/wearable devices, many apps have been made available with stored religious texts, making it easier for worshippers to read along during congregational prayers, without holding a physical printed copy. This is seen, but not limited to, for example, during the month of Ramadan for those of the Muslim faith, when congregational prayers occur on a nightly basis. Prayer-goers during that month tend to follow along with the imam, who recites the Holy Quran verbally.

The problem therein occurs in two fashions; prayer-goers may not know which page to turn to, thus fidgeting, losing time and breaking thoughtful concentration required during prayer, and/or prayer-goers have no understanding/explanations of the verses being read/recited, thus not fully benefiting of the enlightenment that is meant to happen upon reading/reciting/hearing the holy text. For clarity, the explanations of the holy texts are generally referred to as exegesis. For those of the Muslim faith, they are referred to as tafsir. From here on forth, the term exegesis will be used in reference to any explanations of any holy texts from any religions.

Digital technology and hand-held devices have facilitated the physical aspects of holding a heavy printed copy to a lighter digital copy (see patent number PCT/US1995/017109.) But, does not solve the problem of not knowing page or location of recitation. Instead it has simply moved from flipping pages to insistent scrolling up and down. There exist a technology that attempts to solve this issue, using speech processing module to aid in Quranic recitation by using an alignment algorithm (PCT/EP2012/073682.) However, it is our understanding that the method of the alignment algorithm is quite different, than our present invention. Additionally, this technology stops short of solving the second problem, of providing exegesis of the holy texts.

In the scope of education, this present invention could be used in similar manner. Using the example, but not limited to it, a teacher in a classroom could be reading/reciting Shakespeare with the students following along. The location and page of the recitation is pinpointed on a digitized copy, allowing for quicker find and less time wasted. As with the previous example given using religious texts, an associated explanation or commentary of the Shakespearean verse(s) is brought forth. Benefits mentioned and issues solved have been extensively illustrated previously.

### SUMMARY OF THE INVENTION

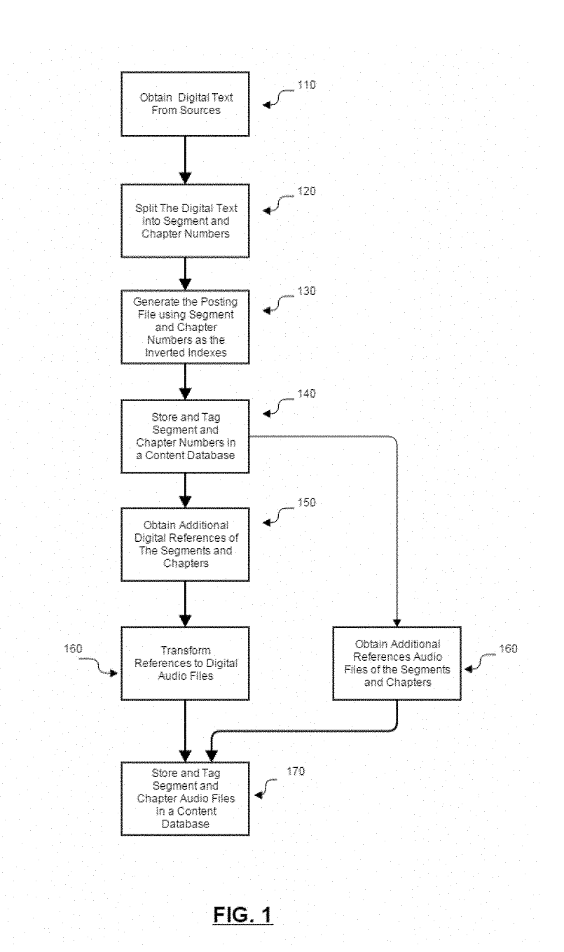

It is the aim of the inventor to use latest technology in ASR combined with natural language processing, to push forth an invention with the ability and capability to intercept natural voice, using it to match exact instances in digitized texts and push forth texts and any associated commentaries and explanations. In accordance to the preferred embodiments of this invention, this system and method uses a three-tier process; publish, retrieve-recall, and broadcast FIG. 1.

This system and method centers around the innovative concept of providing the accurate location of any text (religious/non-religious), while reciting an excerpt of the text into a device equipped with a microphone. In this regard, the embodiments of the present invention aims to collocating the recitals from an already indexed text, recalling the segment of the text, and broadcasting the recalls to reciter (and/or other subscribed users) using various electronic and digital devices. Additionally, the embodiments of the present invention aim in providing establishments and individuals, who rely on texts as an instrument of edification to facilitate their mastery of information.

### BRIEF DESCRIPTION OF THE DRAWINGS

These and other objects of the present invention can be understood from the following detailed description of embodiments of the invention while making reference to the accompanying figures of which:

a. FIG. 1 is a flow diagram depicting content development which is part of the first facet of the present invention;

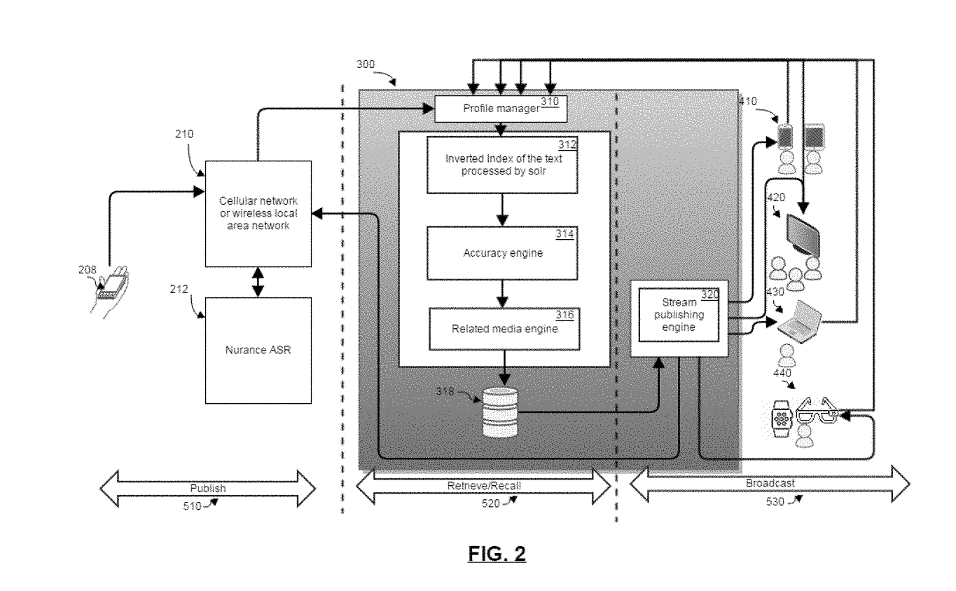

b. FIG. 2 is a schematic diagram showing form of work model and related process flows and responsibilities of the present invention; and

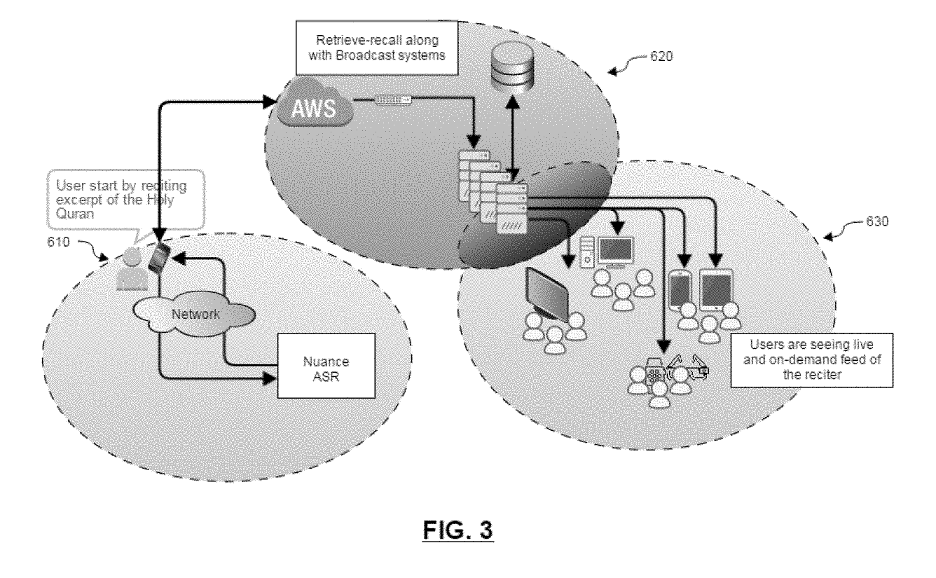

c. FIG. 3 is a schematic diagram showing form of work model and related process in a cloud based environment of the present invention.

### DETAILED DESCRIPTION OF THE INVENTION

The primary facet of the present invention is depicted in FIG. 1 and includes the activity 110 of putting or setting the concerned text so as to be prepared for retrieval. The indexing activity can be conceptualized as, first having the text converted into a posting file, where a relevant section (such as a verse, page, and/or segment number) can be portrayed as the index 120 and 130. The text can also be stored in a conventional content database to use for querying and mapping with other documents that could be depicted as relevant explanations and elaborations of the text segment 140. For instance, taking the Holy Quran (which contains 114 chapters and over 6000 verses) as an example, the segment number can be depicted as the verse number and, thus, can be used as the index in either the posting file or the conventional database. The Holy Quran has an exegesis attributed to each verse. Each exegesis is stored in a conventional database and tagged by the number of corresponding verse. This processing occurs in the primary facet.

In addition to exegesis, since the Holy Quran is in the Arabic language, a plurality of foreign language translations can also be staged as part of the elaborations and be stored in the content database. Furthermore, phonetic material and Text to Speech (TTS) of all these explanations, elaborations, and materials 150, 160, 170 can be preprocessed during the primary facet.

In accordance to the embodiments of the preferred invention, the secondary facet involves the process of reciting from a text, instantly identifying the location within that text, and digitally disseminating the recalled information to the user. As depicted in FIG. 2, this process is handled by three subsystems: the publish subsystem 510, the retrieve-recall subsystem 520, and the broadcast subsystem 530.

In the publish subsystem, the user starts reciting any portion of a text into the mic of any handheld/wearable device 208 which is connected to cellular network or wireless local area network 210. The recorded audio is instantly converted to a text using the ASR application commercially offered by Nuance Communication Incorporated 212. This converted text from audio is presented to the next subsystem (retrieve-recall subsystem) to commence the process of locating and further processing 300. The profile manager 310 is responsible to trace users and memberships using an account management and a credential system. Once the profile manager had completed the authorization process, the converted text is submitted to inverted text system 312 to retrieve the best match of the segment text, and is best handled by the open source Apache Solr application where the creation of the posting file/inverted index is managed and covered in step 120 FIG. 1.

Uniquely, in accordance to the embodiments of this invention, the recitation in step 208 is a continuous process without interruption, the retrieve-recall subsystem does not start its process once the reciter has completed the recitation. But rather, it starts after a few seconds worth of audio input, and continues hereon every other few seconds, with the converted text being continuously fed to this subsystem for locating and retrieving, and work the way down the pipeline. Once this inverted index has pulled the best match of the text, the accuracy engine 314 further certifies the results and may trigger some further adjustments, justifying it with other parameters that may be deemed relevant.

Once a matching segment is appropriately retrieved from the text, now the related media engine in 316 gathers all stored media related content to the exact result match, to be disseminated appropriately. This is performed by the means of querying the content database 318 built in step 140 FIG. 1 and getting the related referrals for that segment text. Now the role of the retrieve-recall subsystem is complete, which signals the broadcast subsystem 530 to be initiated.

The purpose of the broadcast system 530 is to relay all retrieved and recalled information from the retrieve-recall subsystem, to users/members/subscribers to be displayed on the various available devices in the market. This action is performed specifically by the stream publishing engine in 320. Members/users may view the information with a variety and assorted types of devices, which include but not limited to, smartphones and tablets 410, smart TVs 420, desktops 430 and wearables 440. In addition, the stream publishing engine 320 is responsible to exhibit and display the information according to the viewing devices and their ability to play TTS capable information from the content database 318, if the user wishes to do so. Furthermore, the stream publishing engine 320 stores the recited passage and the session in the content database for later retrievals by users/members.

Finally, this invention can be integrated in cloud computing environment, FIG. 3 demonstrates the complete layout in a cloud deployment environment. The publish system 610 is at the device level and all the conversion to text is facilitated through ASR. The texts are sent to the cloud via REST based services 620 to AWS, which is processed on through to stream services constituting the broadcast subsystem 630. The cloud environment is not limited to AWS, and may be any cloud computing companies.

### CONCLUSION, RAMIFICATION, AND SCOPE

The specifications of the present invention are described herein, both in summary and detailed fashion. It is understood that as technology and skills advance, the embodiments of the invention and their applications, summarized or detailed, are not limited to, and may evolve, have substitutions, variations, and changes to their applications and systems of methods, in such a way that does not lose the essence of the present invention. Capacity the embodiments of the invention would be as wide and continuous as technology and imagination pushes forward.

We claim:

1. A system comprising: a handheld computing apparatus receiving an audio signal of verse recitation from a static holy book such as the Quran in real time; the handheld computing comprising a speech recognition interface software application for converting, in real-time, the audio signal into audio digital data representing the audio signal; transmitting, in real-time, the audio digital data from the speech recognition interface software application of the handheld computing to a speech recognition engine of a separately located speech recognition software application comprising means for performing automatic speech recognition on the captured audio signal to produce speech recognition results, and further wherein the computing device is operating a selected profile of a plurality of profiles; transmitting, in real-time, to a third device including a result processing component; a context sharing component comprising: means for receiving, by a processor, a converted text string from audio signals related to verses from the holy books, the query comprising a keyword; identifying, by the processor, the keyword within the query; accessing, by the processor, a verse index containing indexed verses of holy book, the verse index also comprising a unique identifier representing verse number of the identified keyword; retrieving, by the processor from the verse index, results responsive to the query, the results comprising a plurality of verses, the plurality of verses include verses comprising verse number from the holy book;

2. The method of claim 1, wherein the handheld computing apparatus comprises a wireless mobile device.

3. The method of claim 1, wherein the audio signal comprises voice.

4. The method of claim 1, wherein the step of transmitting the audio digital data comprises the speech recognition interface software application of the handheld computing apparatus wirelessly transmitting the audio digital data.

5. The method of claim 1, wherein the step of transmitting the audio digital data comprises the speech recognition interface software application of the handheld computing apparatus wirelessly transmitting the audio digital data using a cellular network or a wireless local area network.

6. The system of claim 1: wherein the system further comprises means for providing the speech recognition results to the result processing component in response to the determination that the result processing component is associated with the current user profile.

7. The system of claim 1, further comprising a remotely located device, wherein providing the means for speech recognition processing component in real time.

8. The system of claim 1, further comprising a remotely located device, wherein providing the means for result processing component in real time.

9. The system of claim 8 further comprising computer readable program code configured to fragment the religious document into a plurality of smaller documents representing verses and separately index the verses individually.

10. The system of claim 8, further comprising providing indexing services using a reusable index structure that includes a defined number of physical index fields to manage the indexing of verses from the religious book.

11. The system of claim 8, the verse search engine comprises a retrieval module that analyzes at least one keyword to determine attributes associated with verse that match the resulting converted text from the speech recognition processing component.

12. The system of claim 1: wherein the system includes other devices further comprises means for providing output representing the result output from result processing component to other users.

13. The system of claim 12, the resulting output further comprises matched verses from the result processing component to other users computing devices and LCD display in real time.
